(19) United States
(12) Patent Application Publication
(10) Pub. No.: US 2016/0265980 A1
(43) Pub. Date: Sep. 15, 2016

(54) SYSTEMS AND METHODS FOR MODELING PRODUCT TEMPERATURE FROM AMBIENT TEMPERATURE

(71) Applicant: CARRIER CORPORATION, Farmington, CT (US)

(72) Inventors: Jonathan Cherneff, Roslindale, MA (US); Martin Meckesheimer, Brookline, MA (US)

(73) Assignee: Carrier Corporation, Farmington, CT (US)

(21) Appl. No.: 15/033,347

(22) PCT Filed: Oct. 27, 2014
(86) PCT No.: PCT/US2014/062384

§ 371 Date: Apr. 29, 2016

Related U.S. Application Data
(60) Provisional application No. 61/898,958, filed on Nov. 1, 2013.

(51) Int. Cl. G01K 3/00; G01K 7/42

(52) U.S. Cl. CPC G01K 3/00; G01K 7/42

(57) ABSTRACT

A system for modeling temperature changes of a product by measuring temperatures of other entities, such as ambient air. A conductance calculation is utilized that describes a relationship between the difference between the logs of temperature differences and the amount of time passed. A method for utilizing the conductance, as well as a method for generating a conductance based on measurements, such as empirical measurements.

### RELATED APPLICATIONS

This application claims the benefit of and priority to U.S. Provisional Patent Application No. 61/898,958 filed Nov. 1, 2013, the contents of which are incorporated herein by reference in their entirety

### FIELD OF THE INVENTION

The present invention relates to modeling temperatures, and more particularly, to modeling product temperatures based on ambient temperature measurements.

### BACKGROUND OF THE INVENTION

Many products, such as refrigerated products, have temperature requirements. It can be prohibitively expensive in terms of both time and money to place thermometers within, or in contact with, the products themselves. Therefore, temperature measurements are typically taken of the surrounding ambient air. However, measuring the temperature of the ambient air can be a poor substitute for the information that is actually desired, i.e., the temperature of the product.

The systems and methods described herein address this problem by modeling the products temperature based on temperature measurements of the ambient medium, such as air.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

The embodiments described herein may be utilized as a “smart” system for estimating an item's temperatures based on measurements of ambient air. Further, the embodiments may be utilized to estimate the temperatures of items positioned in different locations/portions of a container (e.g., a top, middle or bottom portion of a container) wherein each different location may have an item temperature different from items located in other portions of the container.

To achieve these and other advantages and in accordance with the purpose of the illustrated embodiments, described herein are systems and methods for modeling the temperature of an item via temperature measurements of ambient air. In one embodiment, ambient air temperature in a container is measured a first time. This temperature reading is communicated to a modeling engine, which uses the temperature reading to estimate a temperature change of an item in the container. The item has been in the container for an elapsed period of time, and in an exemplary use, the item's estimated temperature change is preferably the product of the elapsed period of time and the change rate.

In yet another embodiment, a model is created for estimating an item's temperature within a container. In this embodiment, the value of the conductance (e.g., constant) k, to be utilized above, is determined. In one embodiment, k is determined by measuring ambient air temperature of an item in a container and also measuring the temperature of the item. These measurements are preferably repeated a plurality of times (e.g., 3 sets of temperature measurements; 200 sets of temperature measurements; 3,000 sets of temperature measurements). For each temperature difference, a log of the temperature difference is preferably calculated. A linear regression may then be calculated based on the charted data points, the result of the linear regression calculation producing the conductance k. For instance, in one example, the conductance k may be found to equal −0.083. However, it is to be understood and appreciated that different embodiments, and different sets of measurements for different items may result in a different conductance k as k is not to be understood to be limited to a single value or particular range.

### BRIEF DESCRIPTION OF THE DRAWINGS

So that those having ordinary skill in the art, to which the present embodiments pertain, will more readily understand how to employ the novel system and methods, certain illustrated embodiments thereof will be described in detail herein-below with reference to the drawings, wherein:

FIG. 1 illustrates a system diagram of an exemplary embodiment of a product temperature modeling system;

FIG. 2 is a flow chart illustrating an exemplary use of the embodiment of FIG. 1; and

FIG. 3 is an illustration of an embodiment of a computing device.

### DETAILED DESCRIPTION OF CERTAIN EMBODIMENTS

The below illustrated embodiments are directed to creating and utilizing a temperature prediction model in which a component or a feature that is common to more than one illustration is indicated with a common reference. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Also, the flow charts described herein do not imply a required order to the steps, and the illustrated embodiments and processes may be implemented in any order that is practicable.

Unless defined otherwise, all technical and scientific terms used herein have the same meaning as commonly understood by one of ordinary skill in the art relating to the below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain embodiments described herein may be utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be executed by a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the certain embodiments described herein. Thus the certain embodiments are not to be understood to be limited by what has been particularly shown and described, except as indicated by the appended claims.

The methods described herein allow users to, in an exemplary use, create and utilize a model for predicting a temperature of items based on temperature readings of ambient air. In one exemplary embodiment of utilizing this method and a given constant conductance k, an item is placed in a container, the item having a temperature that has been measured, estimated, or is otherwise known. After an elapsed period of time, time, a measurement is made of the air's temperature. The following calculation is made to produce a new estimated temperature difference between the item and the ambient air:

ΔTₙ₊₁=k(Aₙ−Tₙ) Equation #1

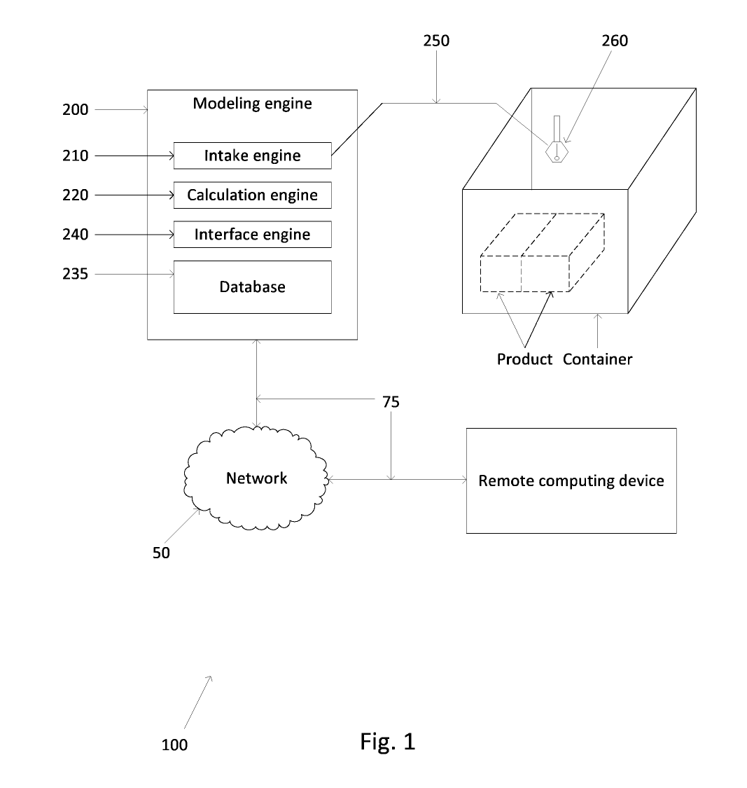

Referring to FIG. 1, a hardware diagram depicting a system 100 in which the processes described herein can be executed is provided for exemplary purposes. In one embodiment, system 100 includes network 50, communications 75, a remote computing device, and modeling engine 200, that includes intake engine 210, calculation engine 220, interface engine 240, database 235, and thermometer 260 communicatively connected with modeling engine 200 via wire 250. However, it is contemplated herein that thermometer 260 may be communicatively connected with modeling engine 200 via any means known in the art, such as wirelessly. Further, products are within a container and thermometer 260 is in the container.

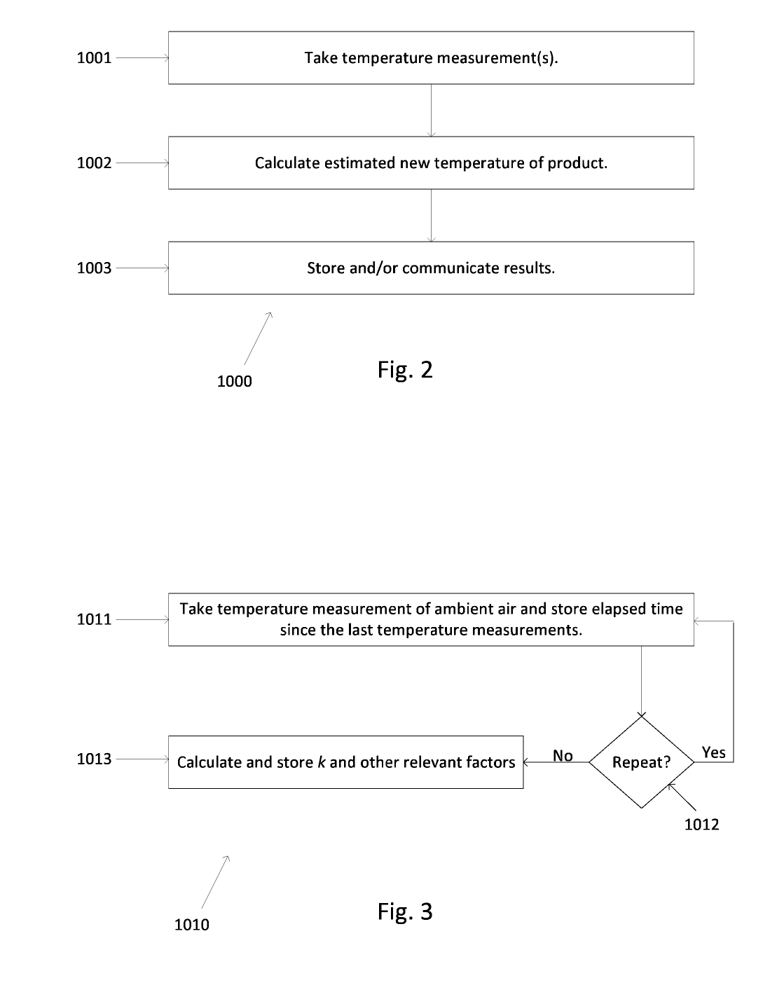

Turning to FIG. 2, illustrated there is in an exemplary process 1000 of utilizing system 100 to calculate estimated temperature(s) of a product based on measurements of ambient air. Starting at step 1001, temperature measurements are taken. In one embodiment, preferably a temperature measurement is taken of the product before it enters the container, and temperature measurements are taken of the ambient air in the container, the air temperature measurements being time apart. In another embodiment, the initial temperature of the product is assumed or supplied.

An estimated temperature of the product is calculated by calculation engine 220 (step 1002). In one embodiment, to calculate a new estimated temperature of the item after a period of time, and previously being given k, a calculation is performed utilizing Equation #1:

ΔTₙ₊₁=k(Aₙ−Tₙ) Equation #1

For instance, in one embodiment, k has a value of −0.083. Given a value for k, the unknown value to be solved for within Equation #1 is the temperature difference, ΔTₙ₊₁, which is the difference between (1) the temperature of the product before time and (2) the temperature of the product after time.

Working through an example, for illustrative purposes only, if the initial temperature difference between the product and the air was 50, after time has passed, then the second temperature difference is 4.15 less, which results in an estimated temperature for the item of 45.85. In another example, if the initial temperature difference between the product and the air was 37, after time has passed, then the second temperature difference is 3.07 less, which results in an estimated temperature for the item of 33.93.

It is contemplated herein that the temperature measurements may be made in Celsius, Fahrenheit, Kelvin, or any scale as known or understood in the art. Further, it is also contemplated herein that the unit of time measurement may be minutes, seconds, hours, days, or any segment of time as known or understood in the art.

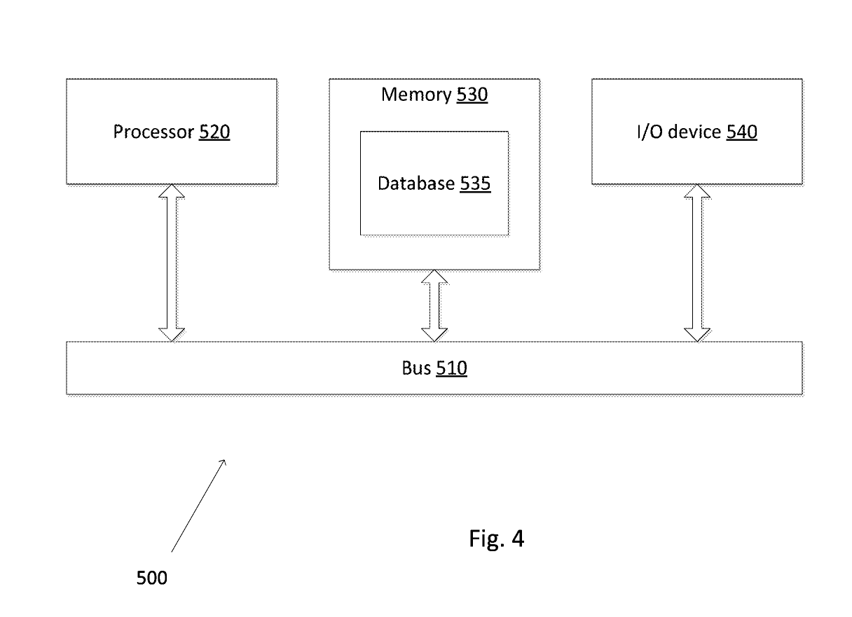

Turning to FIG. 3, illustrated therein is an exemplary process (1010) of creating a temperature estimation model by utilization of a variable k. Starting at step 1011, temperature measurements are taken of both the product and the air. After time, another set of temperature measurements are taken. The measurements are repeated until a graph can be charted of the (1) natural log of the measured temperature difference, and (2) the elapsed time. In one embodiment, the measurements are each performed time apart.

These measurements, and calculations, may be repeated until the data may be placed in a graph that charts the result of the natural log calculations against the time elapsed. A linear regression may then be calculated based on the charted data points, the result of the linear regression calculation producing the constant k. In one example, the conductance k may be found to equal −0.083.

In one embodiment, the object is placed in a controlled environment, such as a heat chamber, until the object reaches approximate and/or actual temperature equilibrium with the controlled environment. The object is then moved to another container at a different temperature. The measurements are thus made of both the object and the temperature of the second container, and those measurements are utilized to calculate k. In another embodiment, field trials are conducted, wherein the temperature of the object and the ambient air of the container are measured a plurality of times, and the measurements are again utilized to calculate k. However, it is contemplated herein that k may be calculated by any means, similar or otherwise, as would be recognized by those skilled in the art.

In the above formulas, the natural log, ln( ), was used. However, it will be recognized by those skilled in the art that any log base m may be utilized and still practice to spirit of this disclosure.

Turning now to FIG. 4, illustrated therein is an exemplary embodiment of computing device 500 that preferably includes bus 510, over which intra-device communications preferably travel, processor 520, interface device 540, and memory 530, which preferably includes hard drive 535. In an embodiment, modeling engine 200 may include computing device 500, and the components thereof.

The term “module”/“engine” is used herein to denote a functional operation that may be embodied either as a stand-alone component or as an integrated configuration of a plurality of subordinate components. Thus, modeling engine 200, intake engine 210, calculation engine 220, and interface engine 240 may be implemented as a single module or as a plurality of modules that operate in cooperation with one another. Moreover, although modeling engine 200, intake engine 210, calculation engine 220, and interface engine 240 are described herein as being implemented as software, they could be implemented in any of hardware (e.g. electronic circuitry), firmware, software, or a combination thereof.

Memory 530 is a computer-readable medium encoded with a computer program. Memory 530 stores data and instructions that are readable and executable by processor 520 for controlling the operation of processor 520. Memory 530 may be implemented in random access memory (RAM), a non-transitory computer readable medium, volatile or non-volatile memory, solid state storage devices, magnetic devices, hard drive, a read only memory (ROM), or a combination thereof.

Processor 520 is an electronic device configured of logic circuitry that responds to and executes instructions. Processor 520 outputs results of an execution of the methods described herein. Alternatively, processor 520 could direct the output to a remote device (not shown) via network 50.

It is to be further appreciated that network 50 depicted in FIG. 1 can include a local area network (LAN) and a wide area network (WAN), other networks such as a personal area network (PAN), or any combination thereof. Further, network 50 in FIG. 1 may include the exact same network configurations, completely different network configurations, or any combination thereof. Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

It should be understood that computing devices 500 each generally include at least one processor, at least one interface, and at least one memory device coupled via buses. Computing devices 500 may be capable of being coupled together, coupled to peripheral devices, and input/output devices. Computing devices 500 are represented in the drawings as standalone devices, but are not limited to such. Each can be coupled to other devices in a distributed processing environment.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer-implemented method of modeling an item's temperature comprising:
measuring a first ambient air temperature in a container with an item that has a first temperature;
communicating the first air temperature to a modeling engine comprising memory and a processor; and
calculating, via the processor, an estimated temperature change of the item, the calculation being at least partly based on the difference between the air's first temperature and the item's first temperature.

2. The computer-implemented method of claim 1, wherein the item was placed in the container for an elapsed time, further comprising:
calculating, via the processor, a change rate that is the product of the calculated temperature difference and a value k; and
calculating the item's estimated temperature change that is the product of the elapsed time and the change rate.

3. The computer-implemented method of claim 2 further comprising:
calculating a new estimated temperature for the item based on the calculated estimated temperature change for the item.

4. A computer-implemented method of generating a model to predict an item's temperature comprising:
measuring an ambient air temperature of a container with an item;
measuring a temperature of the item;
calculating, via a processor, a first temperature difference between the air's temperature and the item's temperature; and
calculating a first log base m of the temperature difference.

5. The computer-implemented method of claim 4 further comprising:
measuring a second ambient air temperature of the container after a time period;
measuring a second temperature of the item approximately contemporaneously with the second air temperature measurement;
calculating a second log base n of the temperature difference between the air's second temperature and the item's second temperature;
calculating a delta temperature that is the difference between the first temperature difference and the second temperature difference; and
calculating a conductance, wherein the conductance is the result of the delta temperature divided by the difference between the first log and the second log.

6. The computer-implemented method of claim 5, wherein m and n each equal the mathematical constant e.

7. The computer-implemented method of claim 5, wherein m and n are equal to each other.

8. The computer-implemented method of claim 4 further comprising:
measuring a second ambient air temperature of the container after a length of time;
measuring a second temperature of the item approximately contemporaneously with the second air temperature measurement;
calculating a second log base m of the temperature difference between the air's second temperature and the item's second temperature;
calculating a delta log that is the difference between the first log and the second log; and
calculating a conductance k, wherein the conductance k defines a ratio between the delta log and the length of time.

9. The computer-implemented method of claim 8, further comprising:
calculating a new variable x, wherein the mathematical constant e to the power of x equals m, and k is defined as the delta log divided by the length of time, and wherein the absolute value of the product of k multiplied by x is between 0.05 and 0.15.

10. The computer-implemented method of claim 9, wherein the absolute value of the product of k multiplied by x is between 0.06 and 0.12.

11. The computer-implemented method of claim 10, wherein the absolute value of the product of k multiplied by x is between 0.065 and 0.10.

12. The computer-implemented method of claim 11 further comprising:
measuring a third ambient air temperature of the container after a second length of time;
measuring a third temperature of the item approximately contemporaneously with the third air temperature measurement;
calculating a third log base m of the temperature difference between the air's third temperature and the item's third temperature;
performing a linear calculation regression to calculate a representation, k, of the slope of (1) the change in the value of the log calculation vs. (2) the change in time.
